(19) United States
(12) Patent Application Publication
(10) Pub. No.: US 2002/0082027 A1
(43) Pub. Date: Jun. 27, 2002

(54) Label information providing method, label information providing program, recording medium recording the label information providing program, commodity used for the label information providing method, and label information providing device

(76) Inventor: Masaya Nagata, Nara-shi (JP)

Correspondence Address: BIRCH STEWART KOLASCH & BIRCH, PO BOX 747, FALLS CHURCH, VA, 22040-0747, US

(21) Appl. No.: 10/026,808

(22) Filed: Dec. 27, 2001

(30) Foreign Application Priority Data
Dec. 27, 2000 (JP) 2000-399571

(51) Int. Cl. H04Q 7/20

(52) U.S. Cl. 455/456; 455/461

(57) ABSTRACT

In a label information providing method, first, a service provider collects label information in a label which is affixed to a bottle, then, stores the collected label information in a storage section in a terminal of the service provider. On the other hand, a consumer affixes a label showing an access destination, which allows a user to obtain label information, to a bottle corresponding to the label information. When the consumer purchases wine, he/she can access the terminal of the service provider with reference to the access destination information included in the label affixed to a wine bottle. When accessed, the terminal of the service provider sends out label information corresponding to access details to a user's terminal, thus allowing the consumer to obtain desired label information as electronic data from the service provider. Consequently, a consumer who purchased wine can obtain a label of the wine, where the label has valuable information, by a simple method.

### FIELD OF THE INVENTION

The present invention relates to a label information providing method, a label information providing program, a recording medium having the label information providing program recorded therein, a commodity used for the label information providing method and a label information providing device, which are capable of accurately reproducing a label which is affixed to a container (bottle, plastic bottle, paper package, or the like) of, for example, wine, beer, any of other alcoholic beverages or the like, and providing the label thus reproduced to a consumer or a demander.

### BACKGROUND OF THE INVENTION

A bottled wine or the like has a label showing various types of information affixed thereon. The various types of information include for example, a trade name, a place of production, a winegrower, an alcoholic content, an amount of wine, an year of harvest of grape, a quality level, or the like. Knowing such information from the label makes it possible to conjecture and check what the wine is like.

Incidentally, many wine drinkers, for example, peels off a label affixed to a bottle so as to keep the label as a memorial of an eating and drinking opportunity. Therefore, a transparent sheet used exclusively for that purpose, which has an adhesive layer formed on one side, is commercially available. The transparent sheet is affixed to a label so that the adhesive faces the label, then, the label is completely transferred to the transparent sheet, thus making it possible to obtain the label.

On the other hand, there is a service which creates and provides an original label including a private snap or the like. In that service above, firstly, a service provider provides label models (for example, frame portions of a predetermined shape) to a service receiver. The service receiver selects a favorite label model from the given models, and submits it with information, such as letters and an image, etc. to be included in the label, to the service provider. The service provider then synthesizes the original information such as the submitted letters, image, and the like, and the model selected by the service receiver, then outputs the label through an image forming device, thereafter sending the label to the service receiver.

However, in the method of peeling off the label with the transparent sheet as described, for example, when affixing the transparent sheet onto the label, if the transparent sheet is not properly affixed, i.e. once the air may go in between the label and the transparent sheet, and/or a crease may appear on the transparent sheet, the air and/or the crease cannot be removed. In that case, the label cannot completely be peeled. Further, even in the case that the transparent sheet is properly affixed to the label, the label cannot completely be peeled when the transparent sheet is not properly peeled away. Therefore, in the case that the transparent sheet is not properly affixed or peeled, the quality of the peeled label is reduced.

Further, in the case where the transparent sheet and the label are bonded loosely or unevenly, only part of the label is transferred while leaving the rest of the label on the bottle, thus preventing the perfect peeling of the whole label.

Further, even if it is possible to go through the foregoing manufacturing steps without problems, an extra care is required in terms of how to peel the label. For example, in the case that the label is nearly broken, it is necessary to put some thought into peeling the label from the other side, or affixing the transparent sheet again and rubbing against the label with something solid. In addition, there is a knack to some extent in peeling the label. If the bottle or the label has irregularities, peeling the label becomes more difficult.

Further, the label is originally bonded to the bottle with an adhesive. Namely, at the time when the transparent sheet is bonded onto one side of the label opposite to the adhesive side, the label is adhered to the both others (the bottle and the transparent sheet). Therefore, if it is possible to peel off only an upper layer (a surface) of the label by this method while leaving a lower layer of the label bonded to the bottle with the adhesive, a mount or the like is needed to hold and conserve the peeled label because the peeled label (the upper layer) is thin.

Further, the rear side of the upper layer of the peeled label is disfigured, as it is the side resulted from the peeling between two layers (the upper layer and the lower layer). The label in that state cannot be used as it is, as a postcard for example, thereby limiting the use of the peeled label.

As described, the greatest drawback to the method of peeling the label by the transparent sheet is the fact that one bottle has only one label. This is the immediate reason why a failure is never allowed when peeling off the label.

On the other hand, in a service which creates and provides an original label, it is possible to obtain only a label. Also, since the label is conserved in a state of electronic information by the service provider, it is possible to make duplicates thereof.

However, this service is not provided with respect to a label affixed to a bottle of wine or the like which is commercially available. The label obtained by this service shows no more than private and original information related to a service receiver. Therefore, for a third party, the label does not have valuable information related to the wine.

A label is originally aimed to serve as a resume showing what the contents (wine in this case) are like. However, a label which is created by the foregoing service merely includes private and original information related to a service receiver, and therefore fails to achieve the original aim. Hence, the information allows a user/consumer neither to obtain information related to a wine itself nor to exchange opinions with a third party as a common topic.

### SUMMARY OF THE INVENTION

The present invention was made to solve the foregoing problems, and an object of which is to provide a label information providing method, a label information providing program, a recording medium in which the label information providing program is recorded, a commodity used in the label information providing method, and a label information providing device, which utilize a label affixed to a bottle of wine or the like which is generally commercially available, and enable a consumer, who purchased a wine, to obtain a label of the wine as having valuable information by a simple method.

In order to attain the foregoing object, a label information providing method according to the present invention includes the steps of: storing label information related to a label, which shows at least commodity information, in storage means by type of a commodity to which the label is affixed; and reading out the label information which is required to be downloaded from the storage means and sending out the label information to a user's terminal when accessed by the user's terminal with reference to access destination information whereby a user requires downloading of the label information related to a label affixed to an arbitrary commodity.

Further, in order to attain the foregoing object, a label information providing device according to the present invention includes: storage means for storing label information related to a label, which shows at least commodity information, by type of a commodity to which the label is affixed; and control means for reading out the label information which is required to be downloaded from the storage means and sending out the label information to a user's terminal when accessed by the user's terminal with reference to access destination information whereby a user requires downloading of the label information related to a label affixed to an arbitrary commodity.

With the foregoing method and arrangement, a label affixed to a commodity includes commodity information such as a trade name, place of production, producer or the like of the commodity, a design to make a better image of the commodity, and the like. The label information including the commodity information and the design information is stored in storage means in a state of electronic data by type of a commodity.

Here, when a label showing the access destination information whereby a user require downloading of label information is, for example, affixed to a commodity, a user can learn of the access destination information when purchasing the commodity. Further, even when the label showing the access destination information is not affixed to the commodity, by, for example, receiving a brochure showing the access destination information from a commodity provider when purchasing the commodity, the user can also learn of the access destination information. Furthermore, publishing the access destination information in a magazine which deals with an article of the commodity allows a user to obtain the access destination information from the magazine, though there is no guarantee for the purchase of the commodity.

When accessed by a user through a user's terminal to require downloading of label information with reference to the access destination information thus obtained, control means reads the label information required to be downloaded out of storage means, then, sends it to the User's terminal, thereby enabling the user's terminal to easily restoring a copy of the original label with reference to the received label information, for example, by a printer or the like.

Thus, any users of the service can easily obtain the label. Further, since the foregoing arrangement enables restoration of the label based on the received label information, failures such as breakage and/or partial acquisition of the label do not occur unlike a conventional method whereby the label is peeled off the bottle by using a transparent sheet, thus preventing a quality of the obtained label from being impaired.

Further, since the label can be restored by a printer or the like based on the received label information, a mount to hold and conserve the restored label is not required when a medium for print (paper) which has an appropriate thickness is selected. Moreover, by doing so, the back side of the restored label is not uglified.

Further, label information is information which indicates exactly what a commodity is like. Therefore, even a label which was restored with reference to the label information has sufficient value as the information indicating what the commodity is like. Consequently, using the restored label, a user/consumer can fully exchange opinions about the commodity with a third party.

In order to attain the foregoing object, a label information providing method according to the present invention includes the steps of: storing label information related to a label, which shows at least commodity information, in storage means by type of a commodity to which the label is affixed; storing the commodity information included in the label information in the storage means by relating the commodity information to the label information; and carrying out a search for label information which is stored in the storage means with reference to inputted commodity information and sending out label information corresponding to a search result to a user's terminal, when accessed by the user's terminal with reference to access destination information whereby a user requires downloading of the label information related to a label affixed to an arbitrary commodity, and the commodity information included in the label information which is required to be downloaded is inputted through the user's terminal.

Further, in order to attain the foregoing object, a label information providing device according to the present invention includes: storage means for storing label information related to a label, which shows at least commodity information, by type of a commodity to which the label is affixed, while storing the commodity information included in the label information by relating the commodity information to the label information; and control means for carrying out a search for label information which is stored in the storage means with reference to inputted commodity information and sending out label information corresponding to a search result to a user's terminal, when accessed by the user's terminal with reference to access destination information whereby a user requires downloading of the label information related to a label affixed to an arbitrary commodity, and the commodity information included in the label information which is required to be downloaded is inputted through the user's terminal.

With the foregoing method and arrangement, a label affixed to a commodity includes commodity information such as a trade name, place of production, producer or the like of the commodity, a design to make a better image of the commodity, and the like. The label information including the commodity information and the design information is stored in storage means in a state of electronic data by type of a commodity.

Here, when a label showing the access destination information whereby a user require downloading of label information is, for example, affixed to a commodity, a user can learn of the access destination information when purchasing the commodity. Further, even when the label showing the access destination information is not affixed to the commodity, by, for example, receiving a brochure showing the access destination information from a commodity provider when purchasing the commodity, the user can also learn of the access destination information. Furthermore, publishing the access destination information in a magazine which deals with an article of the commodity allows a user to obtain the access destination information from the magazine, though there is no guarantee for the purchase of the commodity.

When accessed by a user through a user's terminal to require downloading of label information with reference to the access destination information thus obtained, which is then followed by input, through the user's terminal, of commodity information which is included in the label information required to be downloaded, control means searches for label information stored in the storage means, then, sends the label information corresponding to a search result to the user's terminal, thereby enabling the user's terminal to easily restoring a copy of the original label with reference to the received label information, for example, by a printer or the like.

Thus, any users of the service can easily obtain the label. Further, since the foregoing arrangement enables restoration of the label based on the received label information, failures such as breakage and/or partial acquisition of the label do not occur unlike a conventional method whereby the label is peeled off the bottle by using a transparent sheet, thus preventing a quality of the obtained label from being impaired.

Further, since the label can be restored by a printer or the like based on the received label information, a mount to hold and conserve the restored label is not required when a medium for print (paper) which has an appropriate thickness is selected. Moreover, by doing so, the back side of the restored label is not uglified.

Further, label information is information which indicates exactly what a commodity is like. Therefore, even a label which was restored with reference to the label information has sufficient value as the information indicating what the commodity is like. Consequently, using the restored label, a user/consumer can fully exchange opinions about the commodity with a third party.

Further, in the foregoing arrangement, the control means searches the label information based on the inputted commodity information, then, sends the label information corresponding to the search result to the user's terminal. Therefore, the storage means is no longer required to manage label information, for example, in a state of a file for each commodity. Namely, without management of label information for each commodity by the storage means, desired label information required by a user can be detected by a search conducted by the control means based on the inputted commodity information. Consequently, even when, for example, the volume of label information which is stored in the storage section becomes too large to be easily managed for each commodity, the desired label information can be provided to the user.

In order to attain the foregoing object, a recording medium includes a label information providing program recorded therein according to the present invention, the label information providing program for causing a computer to carry out the steps by the label information providing method.

With this arrangement, by using a computer (for example, a label information providing device) to carry out the program, the processes by the foregoing label information providing method can be attained.

In order to attain the foregoing object, a label information providing method according to the present invention is preferred to further include the step of including the access destination information in the commodity.

Further, in order to attain the foregoing object, a label information providing device according to the present invention is preferred to have an arrangement in which the access destination information is included in the commodity.

With the foregoing method and arrangement, a user can learn, when purchasing the commodity, of access destination information whereby the user can require downloading of label information. In other words, only those who purchased the commodity can learn of the access destination information. Therefore, a label information downloading service which accompanies the purchase of a commodity can be provided to users.

In order to attain the foregoing object, the label information providing method is preferably arranged such that the access destination information is included in the same label that shows commodity information of the commodity.

With this method, since the access destination information and the commodity information are shown in the same label, the both types of information can be included in the commodity at a time by using the label.

Note that, the access destination information may be included in a label either simultaneously with label information or after including the label information in the label. The latter is advantageous in that a modification in the access destination information can flexibly be handled.

In order to attain the foregoing object, the label information providing method according to the present invention is preferred to have an arrangement in which the access destination information is included in a label which is different from a label showing commodity information of the commodity.

With this method, since the access destination information and the commodity information are shown in separate levels, respectively, and the apparent labels can clearly be distinguished from each other, it is unlikely that access destination information shown in one label is mistakenly considered to be part of commodity information shown in the other label.

In order to attain the foregoing object, the label information providing method according to the present invention is preferably arranged such that the access destination information is a URL.

With this arrangement, a user can immediately request downloading of label information only by inputting the URL to a user's terminal.

In order to attain the foregoing object, the label information providing method according to the present invention is preferably arranged such that the access destination information is bar-coded information of the URL.

With this arrangement, a URL can be inputted to a user's terminal by reading out the bar-coded information through a scanner used exclusively for this. Therefore, compared to a case in which the user inputs the URL information to the user's terminal through a keyboard or the like, extra work and effort upon input can be reduced.

In order to attain the foregoing object, the label information providing method according to the present invention is preferably arranged such that the label information is electronic data.

With this arrangement, since the label information is electronic data, restoration, duplicating or the like of the label by using the label information can easily be performed. Further, the label information can also be stored in a medium. Therefore, even when the restoration of the label is failed, it can be tried again using the label information.

In order to attain the foregoing object, a commodity which is used in a label information providing method according to the present invention is used in the foregoing label information providing method, wherein the access destination information is shown on a package.

With this arrangement, it is possible to provide access destination information only to commodity purchasers, and render a label providing service according to a label information providing method of the present invention, as an additional service to the purchase of a commodity only to the purchasers. Further, it is also possible to promote sale of the commodity.

In order to attain the foregoing object, a label information providing device according to the present invention is preferably arranged such that the storage means further stores commodity provider information, the commodity provider who provides the commodity to a user; and the control means judges whether or not commodity provider information inputted from the user's terminal exists in the information stored in the storage means, and only when judging that the commodity provider information exists in the storage means, sends out label information corresponding to a search result to the user's terminal.

With this arrangement, in the case where a user inputs commodity provider information through a user's terminal, the control means sends label information corresponding to a search result to the user's terminal only when the commodity provider information is identical with that stored in the storage means. Accordingly, label information can be provided only to users who actually is provided by a predetermined commodity provider with a commodity (purchased the commodity), thereby establishing a service with respect to the users who purchased the commodity. Further, in order to obtain label information, the user is required to purchase the commodity from the commodity provider. Therefore, the commodity provider can promote sale of the commodity, thereby exploiting the user community who use the present service.

In order to attain the foregoing object, a label information providing device according to the present invention is preferably arranged such that the control means causes the storage means to store user information inputted from the user's terminal.

With this arrangement, based on the user information stored in the storage means, for example, information related to a new commodity and other useful information for a user can be provided to the user.

In order to attain the foregoing object, a label information providing device according to the present invention is preferably arranged such that the control means causes the storage means to store user information and commodity provider information which are inputted from the user's terminal by relating the user information to the commodity provider information.

With this arrangement, a user's use status with respect to a predetermined commodity provider, that is, a commodity sale trend for each commodity provider can be grasped, and the sale trend can be utilized for physical distribution management and/or stock management of the commodity.

Note that, the user's terminal as explained may be existing hardware, such as a currently widespread PC, mobile phone, mobile information terminal or the like.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a flow chart showing an operation flow in a label information providing system which realizes a label information providing method according to the present invention.

FIG. 2 is a conceptual view schematically showing an arrangement of the label information providing system.

FIG. 3(a) is a front view showing an appearance of a bottle having a label which has a label information and access destination information affixed thereto. FIG. 3(b) is a magnified front view showing the details of the label.

FIG. 4 is a block diagram schematically showing an arrangement of a terminal belonging to a consumer and that belonging to a service provider in the label service providing system.

FIG. 5(a) is a conceptual view showing files of label information which are stored in a storage section of the terminal belonging to the service provider. FIG. 5(b) is a plan view schematically showing a printed out result of the label information by using the file of FIG. 5(a).

FIG. 6 is a screen layout showing the details of an initial screen displayed in the terminal belonging to the consumer in the case that the consumer accesses the terminal belonging to the service provider.

FIG. 7(a) is a front view showing an appearance of a bottle to which separate labels respectively showing label information and access destination information are affixed. FIG. 7(b) is a magnified plan view showing the details of the respective labels.

FIG. 8(a) is a back view showing an appearance of a bottle, to the front of which is affixed a label showing label information, and to the back is affixed a label showing access destination information. FIG. 8(b) is a magnified plan view showing the details of the label showing the access destination.

FIG. 9 is a magnified plan view showing a label indicative of the bar-coded access destination information.

FIG. 10 is a screen layout showing the details of a display screen to be displayed by a terminal belonging to a consumer in the case that the consumer accesses a terminal belonging to a service provider, which displays screen prompts the consumer to input commodity information.

FIG. 11 is a screen layout showing the details of a display screen to be displayed by a terminal belonging to a consumer in the case that the consumer accesses a terminal belonging to a service provider, which displays screen prompts the consumer to input commodity information and the name of a shop where the consumer purchased a commodity.

FIG. 12 is a screen layout showing the details of a display screen to be displayed by a terminal belonging to a consumer in the case that the consumer accesses a terminal belonging to a service provider, which displays screen prompts the consumer to input commodity information and the name of a shop where the consumer purchased a commodity and consumer information.

### DESCRIPTION OF THE EMBODIMENTS

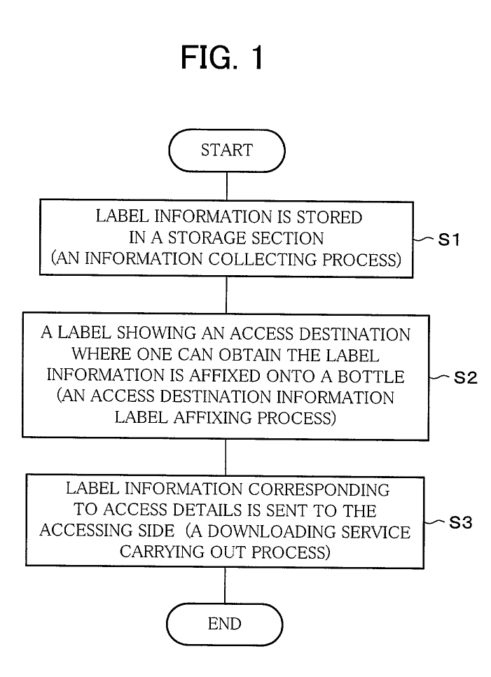

The following will explain one Example of the present invention with reference to FIGS. 1 through 12.

### FIRST EMBODIMENT

The following will explain one embodiment of the present invention with reference to drawings.

### SERVICE OBJECT

In the present invention, a service object which is an object of service is an information recording element which complements commodity information, and an example of which is a label affixed to a wine bottle. To be more specific, an original purpose that the information recording element has is such that it is complementarily and/or obligatorily provided so as to show information on a commodity itself. The information recording element incorporates some image information in addition to textual information for a visual effect. As the image information may be a landscape, an illustration of scenery and/or the like, an artificial creation such as a character or the like, a logo designed by decorating a letter/letters, or a combination of any of these.

Note that, it is easily understood that the service object includes not only the label affixed to a wine bottle but also a design (A) (including a trade name, a logo-mark, a letter and the like) affixed or printed as a label or a sticker onto a bottle or a tin to contain the other liquor (an alcoholic beverage) such as beer, whisky, Japanese Sake or the like, or a non-alcoholic beverage such as coffee, soft drink or the like, and further, a design (B) which is directly printed on a package of a boxed commodity.

The present invention provides a consumer (service receiver, contractant, user) with commodity information, a design and the like as they are included in a label which is affixed to the service object, in a state of electronic data.

### SYSTEM ARRANGEMENT

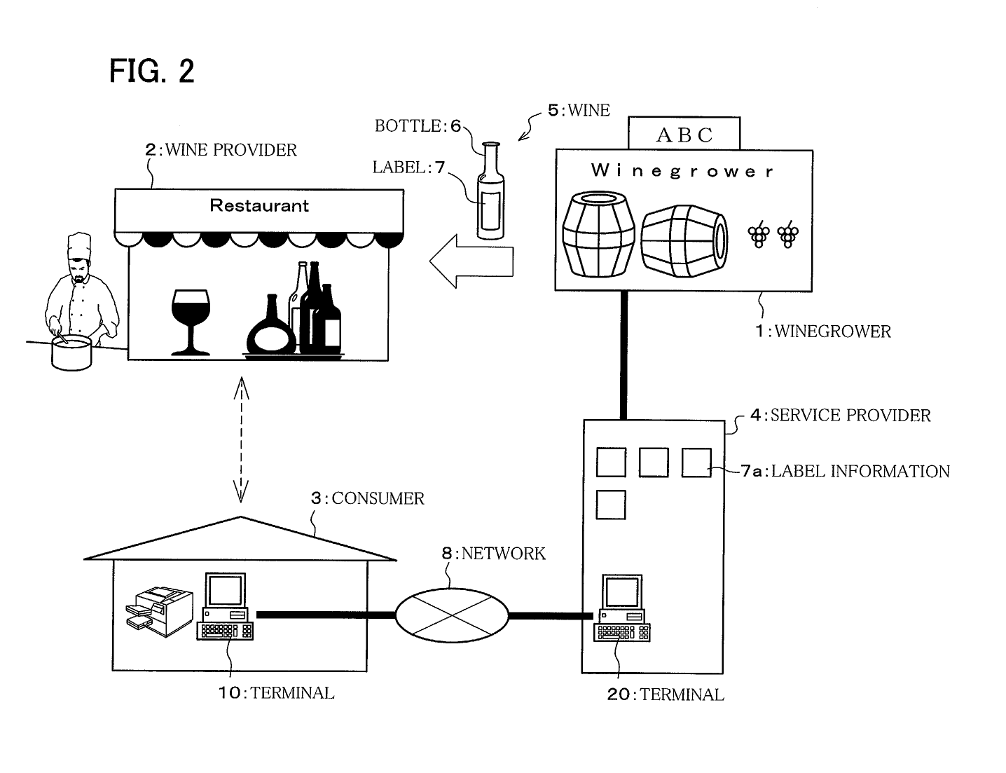

FIG. 2 shows the whole arrangement of a label information providing system which realizes a label information providing method of the present invention, and the flow of a commodity (wine) and information in the case of applying this system to a service which provides wine labels.

In this label information providing system, there is the exchange of the commodity and the information between a winegrower 1, a wine provider 2, a consumer (service receiver, contractant, user) 3, and a service provider 4.

The winegrower 1 produces wine through the processes of growing, harvesting, sorting, fermenting, ageing and the like of grapes from which wine is made. The winegrower 1 then bottles the wine into a bottle 6 to complete the process, thereafter providing it as wine 5 to the market. For example, the winegrower 1 supplies the wine 5 to the wine provider 2. Thus, there exists physical distribution from the winegrower 1 to the wine provider 2.

The wine provider 2 acquires the wine 5 from the winegrower 1, thereafter providing the wine 5 to the consumer 3. The wine provider 2 is not limited to a restaurant owner, but may be a retailer, a wholesaler, and further, a general liquor store, a discount store. Furthermore, the wine provider 2 may be service provider who does not have a shop in terms of a building, as in the case of an e-commerce utilizing the Internet. Thus, there exists direct physical distribution from the wine provider 2 to the consumer 3. Further, via the physical distribution, information on the wine 5 is directly provided from the wine provider 2 to the consumer 3 by a label 7 which is affixed to the bottle 6.

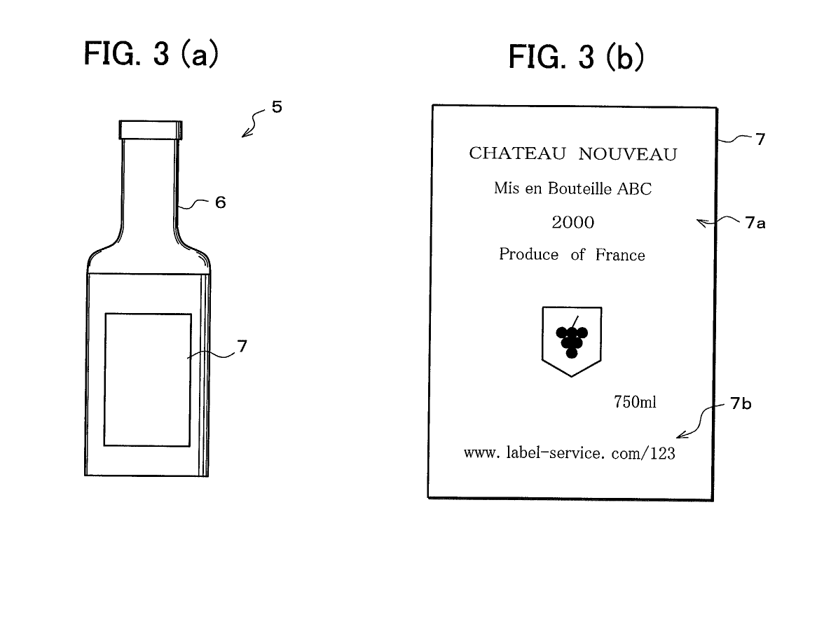

The consumer 3 purchases the wine 5 from the wine provider 2, and obtains the label 7 which is affixed to the bottle 6 as additional information. Here, FIG. 3(a) and FIG. 3(b) show an example of the label 7. The label 7 shows general label information 7a (commodity information) such as a commodity name, a place of production, a winegrower, an alcoholic content, an amount of wine, an year of harvest of grape, a quality and the like, and additionally, access destination information 7b to obtain information identical to the label information 7a as electronic data.

The access destination information 7b is, for example, shown as a URL (Uniform Resource Locator) Further, the access destination information 7b of FIG. 3(b) shows that electronic data of the label information 7a is stored in a file (file name: 123) located in a folder shown as “http://www.label-service.com/”.

Note that, since the electronic data of the label information 7a which is commodity information will be mainly discussed below, “the label information 7a” will hereinafter always refer to electronic data unless otherwise specified.

The file name is made individually by type of the wine 5. Further, the label information 7a in which a trade name and a design are the same as other, but only an year of harvest is different, is treated as different information. Then, two different types of information are respectively stored into separate files. In this case, the other file name is, for example, 124.

As described, having the access destination information 7b on the label 7 in addition to the label information 7a which is commodity information allows the consumer 3 to obtain an access destination to accesses to the service provider 4 from the label 7 affixed to the bottle 6 at the time the consumer 3 purchased the wine 5 from the wine provider 2. This allows the consumer 3 to obtain as electronic data the label information 7a related to the label 7 from the access destination by accessing the service provider 4 through the terminal 10.

As described, there exist flows of information, such as a flow of a request for the label information 7a related to the label 7 of a specific wine 5 from the consumer 3 to the service provider 4, and a flow of providing the label information 7a based on the request, from the service provider 4 to the consumer 3.

The service provider 4 has a terminal 20 which stays on-line with a network 8 to make it accessible from the terminal 10 belonging to the consumer 3 to make access. The network 8 is made up of a public network such as the Internet, a telephone line or the like.

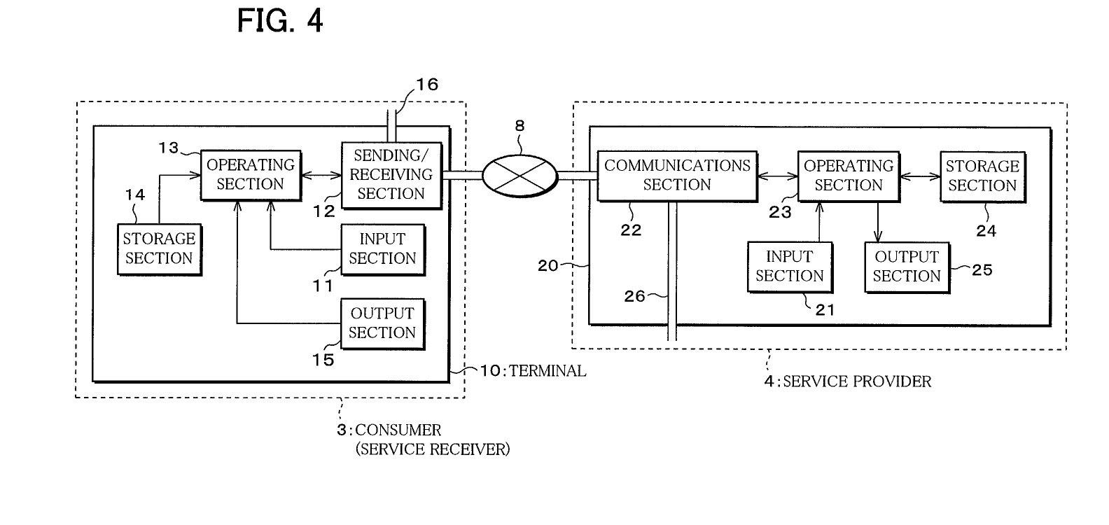

The service provider 4 obtains the label information 7a, which is virtually the same information as that of the label 7 affixed to the bottle 6, in the state of electronic data (electronic file) from the winegrower 1 (to be more exact, a party having authority to create the label 7 of the wine 5), and stores the electronic data to a storage section 24 (see FIG. 4) in the terminal 20. The information communication of the label information 7a from the winegrower 1 to the service provider 4 may be performed either via a removable information storage medium such as a floppy disk, an optical disk or the like, or via a network.

Note that, in the case of having difficulty in obtaining the label information 7a from the winegrower 1 in the state of an electronic file , a method of capturing the label 7 affixed to the bottle 6 as electronic data into the terminal 20 through a scanner or the like, processing the captured image as required, and ensuring a print quality, thereby providing it as service information.

### DEVICE ARRANGEMENT

The following will explain the details of the terminal 10 belonging to the consumer 3, and the terminal 20 belonging to the service provider 4.

FIG. 4 is a block diagram showing an example of a general arrangement and function of the consumer 3 and the service provider 4 on a network. Note that, the simplest network arrangement is such that the terminal 10 belonging to the consumer 3 and the terminal 20 belonging to the service provider 4 are connected.

First of all, the following will explain the terminal 10 belonging to the consumer 3. The terminal 10 (user's terminal) is connected to the terminal 20 belonging to the service provider 4 via the network 8 such as a telephone line or the like. The terminal 10 is made up of an access section and an image forming section. The access section serves as both requesting means to obtain the label information 7a of the wine 5 and receiving means to receive the label information 7a from the terminal 20. The image forming section outputs an image based on the received label information 7a.

More specifically, the access section includes an input section 11, a sending/receiving section 12, an operating section 13 and a storage section 14. On the other hand, the image forming section is an electrophotography printer, an ink-jet printer, a thermal transfer printer or the like, and in the present embodiment, it is the output section 15.

The input section 11 is a connection interface to, for example, a keyboard, a mouse, a pointing device, an image scanner, a barcode scanner and the like, and also either of input devices as described, and is used to input not only the access destination information 7b but also, as required, various types of information such as information on the consumer 3 (name, address, other contact details, etc.), information on the wine provider 2 (the name of the shop where wine was purchased) , and commodity information (the name of the wine 5, the year of harvest, the place of production, etc.). Further, the input section 11 includes, for example, an interface board for capturing output information from a sensor (not shown) into the terminal 10.

The sending/receiving section 12 has such a function as to access the access destination (the terminal 20 of the service provider 4) and receive data from the access destination. Assuming the terminal 10 is a PC, the sending/receiving section 12 administers a connection interface to the network 8 and, in the case that the network 8 is a telephone line, is made up of a modem for example. Further, the sending/receiving section 12 may have a function for accessing a local network 16.

The operating section 13 controls the input section 11, the sending/receiving section 12, the storage section 14 and the output section 15, and performs operation with respect to information inputted from the input section 11 or the sending/receiving section 12. The operating section 13 is made up of, for example, a CPU and a memory. The memory is a RAM or the like which temporarily saves operation results. In the case of carrying out operation using software, a non-volatile memory is prepared for saving a program in which processing steps are recorded. Alternatively, it is possible that the program is saved in the storage section 14 in advance, then, the program is read out of the storage section 14 upon activation so as to be expanded on the RAM for a task.

The storage section 14 stores information which is inputted from the input section 11 or the sending/receiving section 12, and the results of operation performed by the operating section 13. The storage section 14 is made up of, for example, a hard disk and an optical disk. Further, the storage section 14 has such a function as to store an application program and, further, save downloaded electronic data (the label information 7a). More specifically, the application program is, for example, a browser which displays information in the access destination so that a user can view it.

Note that, in the case of realizing the terminal 10 by using existing equipment having the input section 11, the sending/receiving section 12 and the operating section 13, the storage section 14 is not particularly required, though it is generally included. The above equipment includes a PC, a mobile phone, a mobile information terminal (for example, ZAURUS [a registered trademark], a palm computer) or the like.

The output section 15 performs soft copying or hard copying with respect to information. In the case of the former, it is a CRT display, a Liquid Crystal display or the like, and in the case of the latter, it is a printer.

Note that, the output section here refers to a functional portion of an output interface. Besides, if necessary in attaining the final objective to complete the service of the present invention, that is printing out the obtained information, the output section shall include an output device which is connected to the output interface.

This is so arranged on the following grounds: commonly, the image forming section is often arranged as peripheral equipment of the terminal 10 and is therefore considered not to be an inevitable function of the terminal 10; a decision of whether to separately provide this function in an arrangement of the terminal 10 is, for the most part, made by a device maker or the like.

By including the output section 15 in the terminal 10, it is possible to easily and immediately restore a copy of the original label 7 by printing carried out according to the desirable label information 7a which is downloaded from the terminal 20.

Next, the following will explain the terminal 20 belonging to the service provider 4. The terminal 20 (label information providing device) of the service provider 4 is connected to the terminal 10 of the consumer 3 via the network 8 which is a telephone line or the like. The terminal 20 stores the label information 7a so as to provide the consumer 3 with a downloading service of electronic information (the label information 7a) related to various types of the label 7, and manages provision of the desirable label information 7a by request of the consumer 3. The terminal 20 is hardware which forms the principal part of the service management network service according to the present invention.

The terminal 20 is, for example, a personal computer (PC) or a work station (WS), which is, as shown in FIG. 4, made up of an input section 21, a communications section 22, an operating section 23 (control means), a storage section 24 (storage means) and an output section 25. The terminal 20 is placed as a server with respect to the terminal 10 of the consumer 3.

The input section 21 is, for example, a keyboard, a mouse, a pointing device, an image scanner, a barcode scanner or the like. The input section 21 is used when various types of information, such as information on the consumer 3 (name, address, contact details, etc.), information on the wine provider 2 (the name of the shop where wine was purchased, etc.), and commodity information (the name, year of harvest, place of production, etc. of the wine 5), are inputted at an end of the terminal 20 so as to make the storage section 24 store them in advance. The input section 21 further includes an interface board for capturing output information from, for example, a sensor (not shown) into the terminal 20.

The communications section 22 administers a connection interface to the network 8, and in the case that the network 8 is a telephone line, it is made up of a modem, for example. Further, the communications section 22 may have a function for accessing a local network 26.

The storage section 24 stores information which is inputted from the input section 21 or the communications section 22, and the results of operation performed by the operating section 23, and is made up of, for example, a hard disk and an optical disk. Note that, the storage section 24 is equivalent to a recording medium of the present invention. Further, the storage section 24 stores the label information 7a related to the label 7 showing at least commodity information by type of a commodity to which the label 7 is affixed. Note that, explanation in this regard will be made later.

Further, the storage section 24 may store a management file in which information (a company name, a postal address, a contract date, a phone number, an E-mail address, etc.) on the winegrower 1, whom the label information 7a is obtained from, is recorded, an application program in which a processing flow of the service management method of the present invention is recorded, and the like.

The operating section 23 controls the input section 21, the communications section 22, the storage section 24 and the output section 25, while performing operation with respect to information inputted from the input section 21 or the communications section 22, and is made up of, for example, a CPU and a memory. The memory is a RAM or the like, for temporarily saving processing results. In the case of carrying out operation using software, a non-volatile memory is prepared for saving a program in which processing steps are recorded. Alternatively, it is possible that the program is saved in the storage section 24 in advance, then, the program is read out of the storage section 24 upon activation so as to be expanded on the RAM for a task.

Further, the operating section 23 has a function such that, when the consumer 3 accesses it via the user's terminal (the terminal 10) so as to require downloading of the label information 7a related to the label 7 which is affixed to an arbitrary commodity, with reference to the access destination information 7b included in the commodity, the operating section 23 reads the label information 7a, which is required to be downloaded, out of the storage section 24, and sends out the read-out information to the user's terminal via the communications section 22.

The output section 25 performs soft copying and/or hard copying with respect to information, and in the case of the former, it is a CRT display, a Liquid Crystal display or the like, and in the case of the latter, it is a printer. Under circumstances where a paperless project is promoted, and electronic processing (not limited to electronic settlement) is available, the printer is not always required.

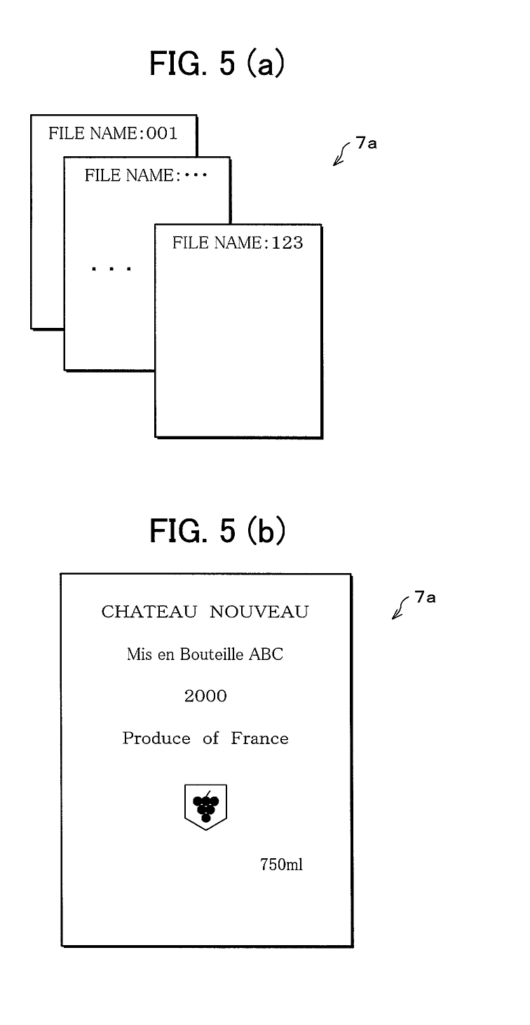

Next, the following will explain storage contents of the storage section 24. As the contents of a database which are stored in the storage section 24 include, for example, the label information 7a of the wine 5 which is shown in FIGS. 5(a) and 5(b).

In the present embodiment, as shown in FIG. 5(a), the storage section 24 creates and manages a file of the label information 7a for each label 7, i.e., by type of a commodity to which the label 7 is affixed. The main body of the file is electronic image information which is created in an appropriate image format such as jpeg (or jpg), bmp, gif, or the like. In the present invention, since a file format which is available to all consumers 3 is necessary, an image format should be for general purpose use. Further, since it is necessity to download such image information that has the equivalent image quality to that of the label 7 affixed to the bottle 6 via the network 8, the volume of information has to be reduced. Therefore, it is preferable that the image information is a high quality image subject to compression.

FIG. 5(b) schematically shows resultant label information 7a which was printed out by an image forming device, using a file name 123. As is clear from a comparison with FIG. 3(b), the label 7 affixed to the bottle 6 is accurately restored except for the access destination information 7b which was added for the present service.

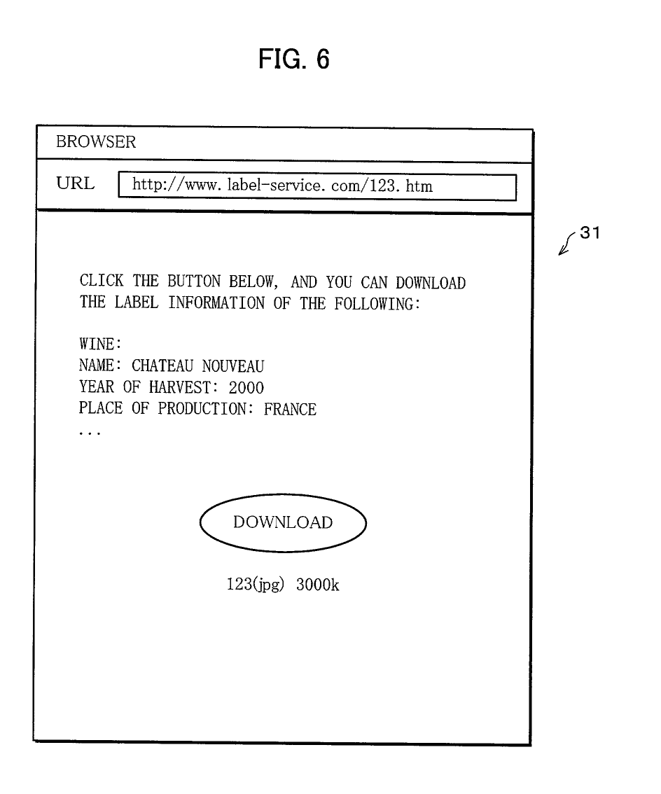

Note that, file information may include not only the image information above but also information to be displayed in an initial screen of the terminal 10 in the case where the consumer 3 accesses the terminal 20 in a downloading service carrying out process which will be discussed later. FIG. 6 shows an example of a display screen for a file name “123.htm” of the terminal 10 belonging to the consumer 3. The file is written in an html (hyper text markup language). Also, text in the drawing shows information (name, the year of harvest, the place of production, etc.) on the wine 5 which is requested by the consumer 3. Thus showing the information in a screen 31 enables the consumer 3 to confirm the details of the label information 7a before downloading, thereby making it possible to decide whether or not downloading should be carried out.

Further, information related to the wine 5 which is requested by a consumer 3, and/or an electronic advertisement from the service provider 4, may be directly displayed, or indirectly displayed by linking, etc., in the screen 31.

### OPERATION OF THE WHOLE SYSTEM

Next, the following will explain the operation of the present system. As shown in FIG. 1, the processing of the present system falls roughly into an information collecting process (S1), an access destination information label affixing process (S2) and a downloading service carrying out process (S3). Note that, the processes of S1 and S2, no matter which one comes first, have to be completed before the process of S3 is carried out.

The following will briefly explain the respective processes above. In the information collecting process, the label information 7a of the label 7 affixed to the bottle 6 is collected by the service provider 4, and the label information 7a is thereafter stored in the storage section 24 of the terminal 20. More specifically, in this process, the label information 7a related to the label 7 which shows at least commodity information is stored in the storage section 24 by type of a commodity (wine 5) to which the label 7 is affixed.

In the access destination information label affixing process, the label 7 showing an access destination (an access destination which allows the consumer 3 to obtain the label information 7a by accessing it) is affixed to the bottle 6 corresponding to the label information 7a. In other words, in this process, the access destination information 7b, which is used by the consumer 3 to require downloading of the label information 7a related to the label 7 affixed to an arbitrary commodity, is included in the commodity.

In the downloading service carrying out process above, the label information 7a corresponding to access details is sent from the service provider 4 to the consumer 3. In other words, in this process, upon access by the terminal 10 based on the access destination information 7b, the label information 7a which is required to be downloaded is read out of the storage section 24 and sent out to the terminal 10.

The following will explain the respective processes above more in detail.

### INFORMATION COLLECTING PROCESS

A service provider 4 obtains label information 7a related to a wine 5 produced by a winegrower 1, from the winegrower 1. To be more precise, in the case that there exist a wide variety of wines 5, the respective label information 7a is saved for each wine 5, as a separate electronic file, in the storage section 24 of the terminal 20.

Here, for example, even a part of the label information 7b is different, as in the case of commodities respectively having the same trade name but different years of harvest, separate files are created and saved for the respective label information 7a. Further, in the case where a plurality of the winegrowers 1 exist, for ease of future management for example, the label information 7a may be stored in the storage section 24 by relating it to winegrower information. Similarly, the label information 7a may be stored in the storage section 24 by relating it to such information as the place of production, year of harvest and the like of the wine 5.

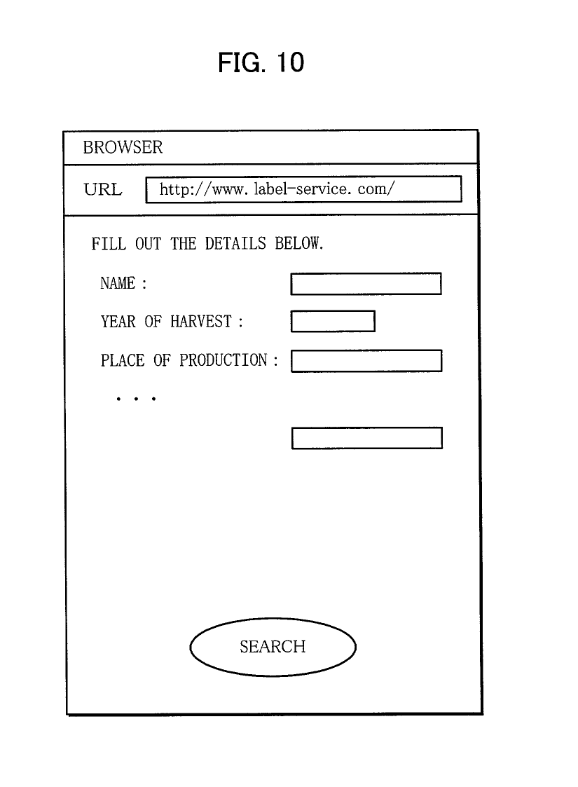

Thus storing information on the winegrower 1 and/or the wine 5 in the storage section 24 enables the consumer 3 to carry out a focused search (see FIGS. 10 through 12) as described in the Second Embodiment below, using the foregoing information related to the label information 7a as a keyword.

Note that, in the foregoing FIG. 5(a), the file name was expressed numerically. In that case, it is necessary to create a management file to relate information thus expressed numerically to general information on the wine 5. However, when the file name is encoded as, for example, “FCN2000.jpg” so that the contents of the file can be conjectured to some extent from the file name, the creation of the management file as discussed is no longer necessary. Here, “F” denotes France as the place of production, and “CN” which comes next denotes the name of the commodity (the initials of “CHATEAU NOUVEAU”), and “2000” which comes last denotes the year of harvest. However, in order to specify the wine 5, information such as the name of a winegrower, a quality level and the like should be provided, and the file name can be too long if all the information required to specify the wine 5 are used in the file name. Therefore, it is preferable that the method of encoding the file name like this is used in combination with the management file.

As explained, electronic files are stored by type of wine so that a database is formed in the storage section 24 of the terminal 20 which is managed by the service provider 4.

### AN ACCESS DESTINATION INFORMATION LABEL AFFIXING PROCESS

An access destination information label is the label 7 in the case of including the label information 7a and the access destination information 7b in the same label 7 as shown in FIG. 3(a) and FIG. 3(b) . The access destination information 7b may be included in the label 7 when printing the label 7, simultaneously with the label information 7a which is commodity information. Alternatively, the access destination information 7b may be included in the label 7 by another image forming method, after printing the label information 7a onto the label 7. In the latter method, image forming steps increase compared to the former method; however, this can be carried out by a method such as electrophotography image formation or ink-jet image formation, which is easier to handle than printing; therefore, even in the case where a URL is modified for example, only a modification in electronic data should be made without modifying a block copy or the like. Accordingly, the latter method has advantages in terms of easy handling, faster speed, and adding no extra costs.

In the present process, the access destination information label (the label 7) made through the process above is affixed to the bottle 6 of the wine 5.

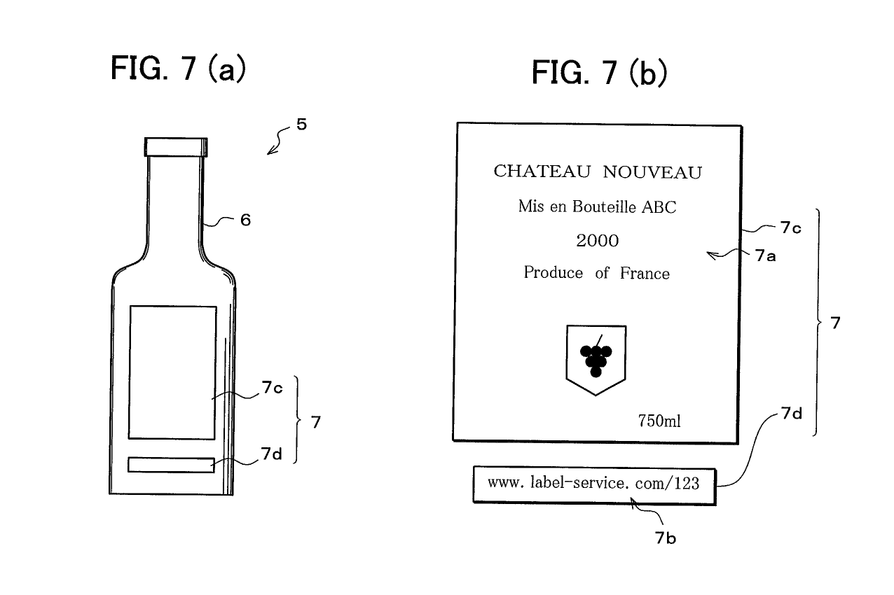

Incidentally, in the present process, as shown in FIG. 7(a) and FIG. 7(b), a label 7 can be made up by printing the label information 7a which is commodity information onto a label 7c while printing the access destination information 7b onto a label 7d (an access destination information label) which is provided separate from the label 7c, thereafter affixing the label 7c and the label 7d separately to the bottle 6. The reason is shown below.

As shown in FIG. 3(a) and FIG. 3(b), in the case that the label information 7a and the access destination information 7b are included in a single label 7, the access destination information 7b which is created according to the present invention can possibly be misunderstood as the original information on the wine 5 by being mixed up with the label information 7a.

Moreover, the timing of printing the access destination information 7b onto the label 7 is limited to a point, basically, before affixing the label 7 to the bottle 6. The reason is as follows: when the label 7 which first includes the label information 7a alone is affixed to the bottle 6, and an attempt is made to print the access destination information 7b onto the label 7 thereafter, a curved shape of the bottle 6 on which the label 7 is formed following the curve of the bottle 6 prevents an ordinary printer, which is designed to print only on a flat surface, from printing the access destination information 7b onto the label 7 without distortion.

In contrast, as shown in FIG. 7(a) and FIG. 7(b), when the label 7 is made up by providing two separate labels 7c and 7d, the apparent labels 7c and 7d are clearly distinguished from each other. Therefore, there is little possibility of mixing up the access destination information 7b printed on the label 7d with the label information 7a printed on the label 7c, and the access destination information 7b can hardly be misunderstood as the original information on the wine 5 accordingly.

Further, by printing the label information 7a and the access destination information 7b respectively onto the separate labels 7c and 7d, the access destination information 7b can be printed onto the label 7d by a different system from a system of printing the label information 7a onto the label 7c. Further, affixing the label 7d to the bottle 6 does not have to be at the same timing as that of the label 7c. This makes it possible to affix the label 7d to the bottle 6 before or after affixing the label 7c, thereby greatly alleviating a limitation given to the affixing timing.

Here, if the label 7d is affixed to the bottle 6 before, or simultaneously with, affixing the label 7c, this is added as an extra working step to the winegrower 1, thereby increasing the load of the winegrower 1. However, when carrying out the work for affixing the label 7d after shipping the wine 5 from the winegrower 1, that is, in the case where, for example, the wine provider 4 receives the wine 5 from the winegrower 1, then, creates and affixes the label 7d, no extra load is given to the winegrower 1. Therefore, this has the merit of making it easy to obtain the winegrower's cooperation.

Further, by performing the process of including the access destination information in the bottle 6 (a work for affixing the label 7c to the bottle 6), which is the principal work to realize the service, under the service provider's management and responsibility, it is possible to prevent a trouble such that the access destination information 7b is not printed onto the label 7c due to the winegrower 1's mistake, thereby providing a high quality service.

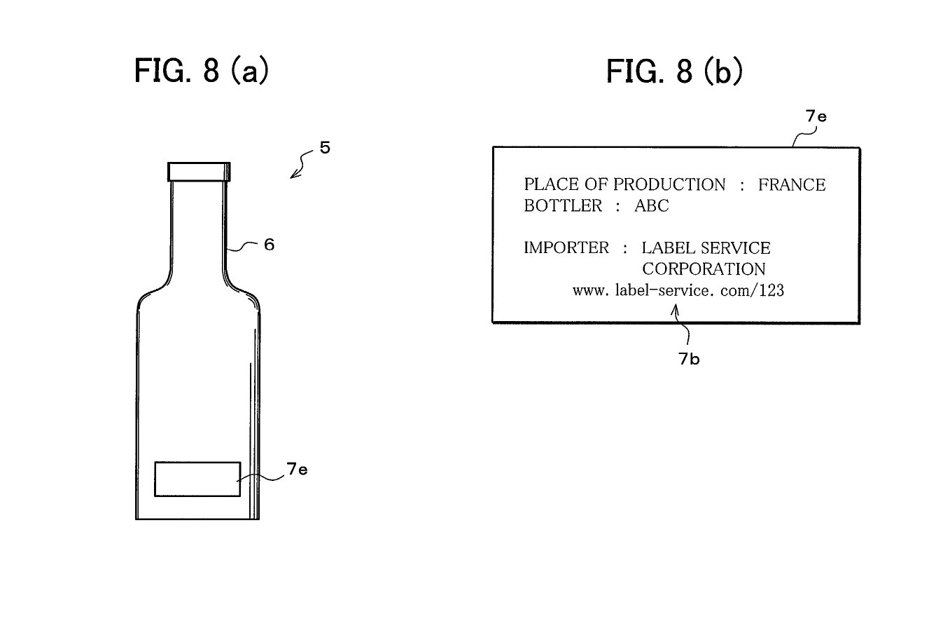

Further, in the case that the wine 5 is an imported commodity or the like, commonly, as shown in FIG. 8(a), in order to display information such as the importer's name, etc., a label 7e which shows the foregoing information is often affixed to a surface of the bottle, which is opposite to a side to which the label 7(7c) is affixed. In that case, as shown in FIG. 8(b), the access destination information 7b may of course be included in the label 7e.

Further, the foregoing explanation has been made through the case where a URL is used as the access destination information 7b. This, however, can be time-consuming in that information on the URL has to be inputted to the terminal 10 to access the URL. Further, another problem is such that desired information cannot be obtained when wrong information is inputted.

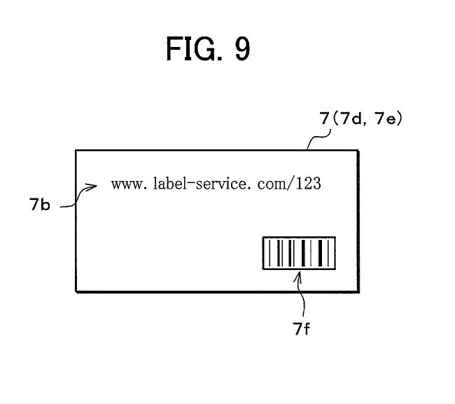

Therefore, for example, as shown in FIG. 9, a label 7(7d, 7e) which includes the access destination information 7b as barcode information 7f may be affixed to the bottle 6. In this case, in the downloading service carrying out process to be described below, it is possible to access a desirable URL not only automatically but also easily by using other service which captures the bar-code information 7f through its own reading device and thereby decodes the bar-code information 7f.

### DOWNLOADING SERVICE CARRYING OUT PROCESS

Here, the following will explain an example of using the Internet as access means and a browser as display software.

In FIG. 4, first, by establishing communication on the consumer 3's side, the terminal 10 is connected to the network 8. Next, in a state that the browser is activated in the terminal 10, the consumer 3 inputs through the input section 11 the access destination information 7b (for example, “www.label-service.com/123.htm”) shown in the label 7 which is affixed to a bottle of the wine 5 purchased from the wine provider 2. Thereafter, communication is made between the terminal 10 and a server (the terminal 20 of the service provider 4) by a function of the browser.

In the terminal 20 of the service provider 4, the communications section 22 receives access from the terminal 10, and the operating section 23 analyzes the details of a request from the terminal 10. For example, when downloading the file name 123.jpg is requested, the operating section 23 retrieves information (123.htm) related to the file 123, which should be displayed in an initial screen of the terminal 10, from the storage section 24, then, sends the information from the communications section 22 to the terminal 10.

When the sending/receiving section 16 of the terminal 10 receives the information of the URL, the operating section 13, as shown in FIG. 6, displays the information in a display section of the output section 15. The consumer 3 clicks a downloading carrying out button inside a screen 31 after checking whether or not the information displayed corresponds to the label information 7a that should be downloaded. Note that, additional information of an image format and an image file size is displayed as a guide for downloading.

Detecting that the consumer 3 clicks the downloading carrying out button after receiving the information (123.htm) by the terminal 10, the operating section 23 of the terminal 20 then sends an image file (file name: 123.jpg) to the terminal 10 via the communications section 22, thereby carrying out downloading of an image.

At this time, the consumer 3 specifies or modifies a storing directory for the image file through the input section 11, thereby downloading the image file into the preset directory in the storage section 14.

When downloading is properly completed, the terminal 10 and the network 8 may be disconnected. Thereafter, the consumer 3 prints out the downloaded image file through the output section 15. If color matching and the like are guaranteed, no special editing session is needed, and printing is carried out by opening the downloaded image file and clicking a print command. Consequently, a label 7 having the equivalent details to the label 7 that is affixed to a bottle of the purchased wine 5 is restored.

As explained above, in the present embodiment, while storing label information 7a for each of various wines 5 in the storage section 24 in the terminal 20, a label 7 (7b, 7e) having access destination information 7b is affixed to a bottle 6 of each wine 5. This enables a consumer 3, who purchased the wine 5, to access a service provider 4 with reference to the access destination information 7b, thereby obtaining desired label information 7a in a state of electronic data from the service provider 4. As a result, as described, based on the label information 7a can easily be restored, by a printer or the like, a label having the same quality as that of the label 7 affixed to the bottle 6.

Therefore, failures such as breakage and/or partial acquisition of the label 7 do not occur unlike a conventional method whereby the label 7 is peeled off the bottle 6 by using a transparent sheet. Consequently, a consumer 3 who purchased a wine 5 can easily obtain the equivalent of a label 7 of the wine 5 without impairing its quality.

Further, label information 7a is information which indicates exactly what a wine 5 is like. Therefore, even a label 7 which was restored with reference to the label information 7a has sufficient value as a resume of the wine 5. Consequently, using the restored label 7, a user/consumer can fully exchange opinions with a third party.

Note that, in the present embodiment has been described an example in which a label 7(7b, 7e) showing access destination information 7b is affixed to a bottle 6 of a wine 5. However, the label 7 should not necessarily be affixed to the bottle 6. Instead, there may be adopted, for example, a method of printing the access destination information 7b onto a tag and placing the tag around the bottle 6.

Likewise, affixing a label 7 to a bottle 6 is also not required when, for example, the consumer 3 can learn of access destination information 7b, which was provided from a wine provider 2, by receiving a brochure, etc., which includes the access destination information 7b when purchasing a wine 5. In this case, similarly, a downloading service of the label information 7a can be provided only to those who purchased a wine 5.

Further, in the case where the target of the service is not particularly wine purchasers, for example, publishing access destination information 7b in a magazine which deals with an article of a wine 5 enables a user to obtain the access destination information 7b by purchasing the magazine, thereby making it possible to require downloading of label information 7a.

Accordingly, the access destination information affixing process above is not always required to realize the label information providing method according to the present invention. Nevertheless, by carrying out the access destination information affixing process, it is possible to surely render a label information 7a providing service which targets wine 5 purchasers only.

### SECOND EMBODIMENT

The following will explain another embodiment of the present invention with reference to drawings. Note that, for ease of explanation, arrangements equivalent to those shown in the drawings pertaining to the First Embodiment above will be given the same reference numerals, and explanation thereof will be omitted here.

In the foregoing First Embodiment, an access destination with respect to label information 7a was applied to a bottle 6 by type of wine 5. This, however, raises a problem such that information management/formation becomes difficult as types of the wine 5 increase. In order to solve this problem, the present embodiment has an arrangement in which only URL information (excluding a file name) of the terminal 20 for providing the present service is used as access destination information 7b to be shown on a bottle, and a desired label 7 is specified by a search which is performed according to input at a consumer 3's end. FIGS. 10 through 12 show examples of a search screen which is displayed in a terminal 10 as a result of the consumer's access to a terminal 20 belonging to a service provider 4, where the access was made with reference to a URL included in the label 7.

Among these, FIG. 10 is an example of the search screen in the case where the consumer 3 inputs wine information alone. This shows the most basic screen. Information necessary to search for a wine 5, such as the name, year of harvest, place of production and the like of the wine 5 are previously stored in the storage section 24. The consumer 3 inputs the information necessary to search for the wine 5 via a display screen shown in FIG. 10. Thereafter, when clicking a search button, an operating section 23 of the terminal 20 searches for label information 7a which is stored in the storage section 24, with reference to the inputted information as a keyword.

If there is no mistake in the information inputted to the terminal 10, the operating section 23 causes the terminal 10 to display search results in the same screen 31 as that shown in FIG. 6. However, if there is any mistake in the inputted information, or in the case of inputting information which is not covered by the service, at the end of the terminal 10, the operating section 23 causes the terminal 10 to show an error message, such as “the inputted information does not exist in this database” or the like, which message is a prompt to demand another input as well as a warning. In the screen 31 of FIG. 6, when the downloading carrying out button is clicked, the operating section 23 sends out the label information 7a corresponding to the search results to the terminal 10.

As described, when accessed by a consumer 3 from the terminal 10 with reference to access destination information 7b to require downloading of label information 7a related to a label 7 which is affixed to a desired commodity, then, receiving, from the terminal 10, input of commodity information which is included in the label information 7a required to be downloaded, the operating section 23 searches for the label information 7a stored in the storage section 24 according to the inputted commodity information, thereafter sending out the label information 7a corresponding to search results to the terminal 10.

Accordingly, the storage section 24 can detect label information 7a which is desired by a consumer 3 through a search conducted by the operating section 23, without managing label information 7a for each commodity. Therefore, the arrangement according to the present embodiment becomes remarkably effective in the case where the volume of label information 7a which is stored in the storage section 24 becomes too large to be easily managed for each commodity.

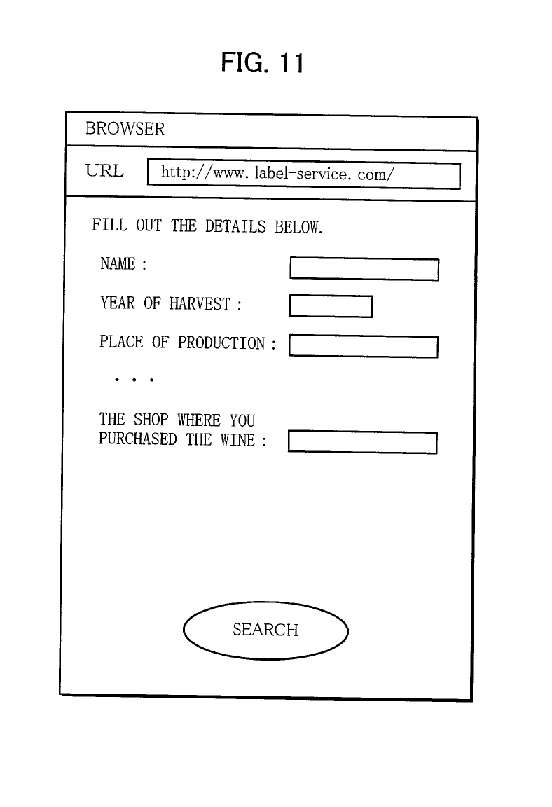

Further, FIG. 11 shows an example of a display screen of the terminal 10 in the case of further requiring input of name information of a shop where a user purchased a wine (wine provider information) in addition to the wine information above. Note that, in this case, a prerequisite is that the service provider 4 stores not only the wine information but also the name information of the shop where the user purchased the wine in the storage section 24 in advance in a state of a database. The operating section 23 judges whether or not the name of a shop inputted from the terminal 10 is a registered shop name. Only when the inputted name and a registered shop name are identical, the operating section 23 sends search results to the terminal 10.

Assuming that the purpose of the present service is basically to provide an additional service to wine 5 purchasers, it is desired that only the wine purchasers can access the present search database. It is as one means for realizing this that the name of a shop which sold/provided the wine 5 is required to be inputted as described.

Note that, the name of a shop where a user purchased a wine may be inputted either directly or by encoding information like “181507”, etc. When encoding, a file in which a relation with the actual name, etc. is recorded is created and stored in the storage section 24, which file is referred to decode the encoded information.

Further, it is likely that a consumer 3 who used the present service before accesses the present search database again, attempting to obtain a label 7 of a different wine 5 without purchasing the different wine 5. In order to block access from users having that attempt, the service provider 4 may demand input of a password instead of the name of a shop. A possible way of offering information on the password is such that a wine provider 2 offers it to a consumer 3 in accordance with a type of wine 5 purchased.

In other words, it may be arranged such that the storage section 24 stores commodity provider information (the name of a shop), the commodity provider who provides a commodity (wine 5 in this example) to a consumer 3, and/or a password which is provided from the commodity provider (wine provider 2), then, the presence or absence of the commodity provider information and/or the password inputted from the terminal 10 in information stored in the storage section 24 is judged by the operating section 23, and only when the presence of the commodity provider information and/or the password in the storage section 24 is confirmed, the operating section 23 sends label information 7a which corresponds to search results to the terminal 10.

Further, since the service provider 4 can obtain name information of a shop where wine was purchased, he/she can collect information such as “from which wine provider 2 a wine 5 is sold best”, etc. Further, by providing feedback based on the collected information to the wine provider 2 and in turn to the winegrower 1, the service provider 4 can manage physical distribution as well.

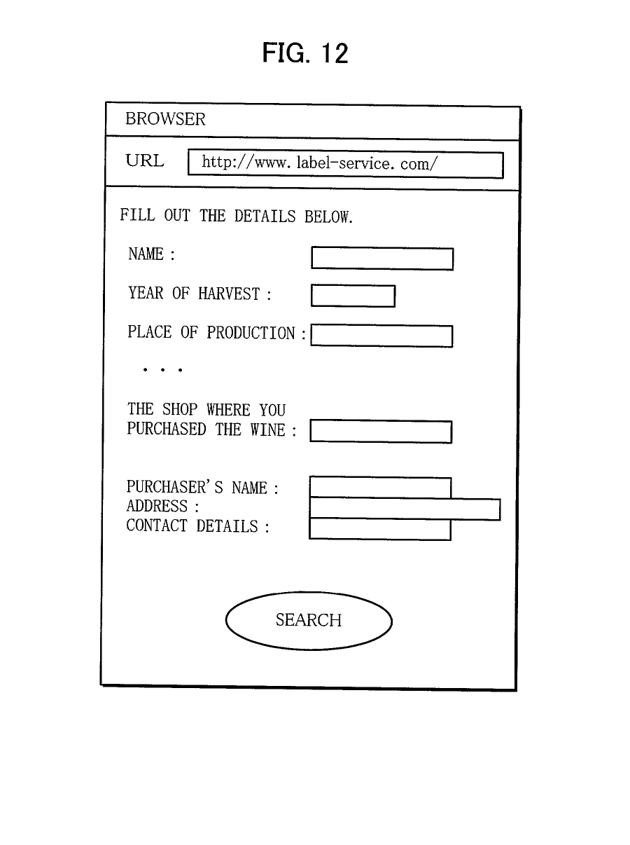

Meanwhile, FIG. 12 is an example of a display screen of the terminal 10 in the case of further requiring input of user information (information on a consumer 3), such as the name, postal address, contact details and the like of a wine 5 purchaser, in addition to the information inputted as shown in FIGS. 10 and 11. Note that, The user information inputted at the end of the terminal 10 is, by control of the operating section 23, stored in a user information table so as to be managed on a user by user basis.

In this case, the service provider 4 can thus obtain information on the consumer 3 as user information. Therefore, in addition to the effect above, it is possible to advise the consumer 3 of information related to the wine 5, for example, useful information such as discount information, arrival information and the like by post or E-mail, thereby producing a ripple effect after sale.

Further, by relating the name of a shop where a user purchased a wine (=a wine provider 2) to user information (=a consumer 3), it is possible to make good use of the user information for a further activity of additional services to be provided from the wine provider 2 to the consumer 3. Note that, relating the name of the shop and the user information is managed for each consumer 3 by the control of the operating section 23, for example, in the service management table in the storage section 24.

Note that, information which is included in an actual label 7 and label information 7a which is provided as electronic data should not necessarily be identical; for example, information contained in the label 7, which is considered unwanted, may be excluded from the label information 7a on purpose. For example, when a commodity is food or the like, a label 7 or the like shows ingredients, etc., in addition to image information. Then, when it is admittable that only a design of the label 7 is useful, textual information may be deleted from the original image information of the label information 7a.

Incidentally, the processes performed by the terminal 20 as explained in the foregoing embodiments are executable by a program. The program is stored in a computer-readable recording medium. In the present invention, the recording medium may be either of the storage section 24, a memory (for example, a ROM itself) which is not shown and required to carry out processing in the terminal 20 of the service provider 4, and any of program media, which has a program read-out device as an external storage device, though not shown, and becomes readable by inserting a recording medium thereto.

In either case, the stored program may be arranged either to be executed upon access of a micro processor (not shown) or to be executed by reading out the stored program, thereafter downloading the read-out program to program storage areas, though not shown, of a distribution server and a receiving server. In the latter case, a program for downloading use is previously stored in a main body device.

Here, the program media above are recording media which are arranged to be removable from the main body, and may be the media selected from (a) a tape system such as a magnetic tape, a cassette tape or the like, (b) a disk system which includes a magnetic disk such as a floppy disk, a hard disk or the like and an optical disk such as a CD-ROM, an MO, an MD, a DVD or the like, (c) a card system such as an IC card (inclusive of a memory card), an optical card or the like, and (d) a semiconductor memory such as a mask ROM, an EPROM, an EEPROM, a flash ROM or the like.

Further, since the present invention has a system configuration which is accessible to a communications network which includes the Internet, it may be arranged that a program can be downloaded from the communications network. Note that, in the case of thus downloading a program from the communications network, the program to be downloaded may be either previously stored in the main body device or installed from a different recording medium.

Note that, contents stored in the recording medium are not particularly limited to the program, and it may be data as well.

The description above has revealed that a recording medium in which a label information providing program is recorded according to the present invention, the program causes a computer to carry out the steps of: storing label information related to a label, which shows at least commodity information, by type of a commodity to which the label is affixed; and reading out the label information which is required to be downloaded from the storage means and sending out the label information to a user's terminal when accessed by the user's terminal with reference to access destination information whereby a user requires downloading of the label information related to a label affixed to an arbitrary commodity.

Further, a recording medium in which a label information providing program is recorded, the program causes a computer to carry out the steps of: storing label information related to a label, which shows at least commodity information, by type of a commodity to which the label is affixed, while storing the commodity information included in the label information by relating the commodity information to the label information; and carrying out a search for label information which is stored in the storage means with reference to inputted commodity information and sending out label information corresponding to a search result to a user's terminal, when accessed by the user's terminal with reference to access destination information whereby a user requires downloading of the label information related to a label affixed to an arbitrary commodity, and the commodity information included in the label information which is required to be downloaded is inputted through the user's terminal.

Further, the label information providing method explained above may alternatively be described as first to third label information providing methods shown below.

The first label information providing method includes the steps of registering electronic data related to a label which shows commodity information, including an access destination of the electronic data in a commodity, and sending out electronic data corresponding to access details to the accessing side.

With this method, it is possible to provide identical information identical with information included in a label, a sticker or the like affixed to the commodity, in a state of electronic data, and a service receiver who receives the service can obtain the information by an easy method and/or means. Further, since information identical to the label is provided in the state of electronic data, restoration, duplicating and the like can be performed. Therefore, there is a merit such that, even when the formation of information is failed, it can be tried again.

Further, when it is arranged to require, upon access, input of information on a shop where a purchaser purchased the commodity and, further, purchaser information in addition to the commodity information, the access can be limited to those who actually purchased the commodity. Therefore, the service can be more than a mere free data providing service, thereby exploiting the service receiver community who actually purchases a commodity to receive the service of the present invention.

Further, if relating information on a shop where a purchaser purchased a commodity to purchaser information, it is then possible to obtain sale trends information on the commodity, thereby effectively utilizing the information for physical distribution management and stock management. Further, this enables the shop to render a sale promotion service with respect to the purchaser.

The second label information providing method, in the first label information providing method, is arranged to use a URL as the access destination information of the electronic data.

With this method, only the use of existing hardware, such as a currently widespread PC (personal computer), mobile phone or the like and the Internet technology (Internet connection service such as i-mode or the like) enables requesting and acquisition of the electronic data.

The third label information providing method, in the second label information providing service, is arranged to use bar-coded URL information as the access destination information of the electronic data.

With this method, there can be reduced extra work and effort needed in inputting the URL information to information access means such as a PC, a mobile phone, a mobile information terminal or the like.

Further, a commodity of the present invention is an information recording element in which commodity information is recorded, which element, for example, includes access destination information required to download electronic data of information which is shown in a label, a package or the like. This realizes the label information providing method by a simple method.

Further, by creating an information recording element in which access information is recorded separately from a conventional label, the information recording element can be made separately from the label, and affixed to a commodity through a different manufacturing process. Therefore, for example, the information recording element having the access destination can be created and affixed by a third party such as a service provider or the like, after shipping the commodity from a manufacturer thereof, thereby creating the access information required in the present invention without increasing a load of the manufacturer.

Further, a label information providing device of the present invention may be described to include a storage section which registers electronic data related to a label which includes commodity information, a communications section which accepts downloading of the electronic data, and an operating section which specifies desired electronic data among the registered electronic data.

With this arrangement, it is possible to provide information via a network in addition to a conventional physical distribution service, by previously registering the electronic data related to the label which includes commodity information.

Further, if it is arranged that, when registering, electronic data information and the commodity information such as a trade name, a producer, an year of production, a quality group or the like are related to each other and stored in the storage section, it is then possible to specify and/or search for desired data from among a plurality of electronic data based on the commodity information, thereby omitting access destination information to be included in the commodity.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A label information providing method, comprising the steps of:
storing label information related to a label, which shows at least commodity information, in storage means by type of a commodity to which the label is affixed; and
reading out the label information which is required to be downloaded from the storage means and sending out the label information to a user's terminal when accessed by the user's terminal with reference to access destination information whereby a user requires downloading of the label information related to a label affixed to an arbitrary commodity.

2. The label information providing method set forth in claim 1, further comprising the step of:
including the access destination information in the commodity.

3. The label information providing method set forth in claim 2, wherein:
the access destination information is included in the same label that shows commodity information of the commodity.

4. The label information providing method set forth in claim 2, wherein:
the access destination information is included in a label which is different from a label showing commodity information of the commodity.

5. The label information providing method set forth in claim 1, wherein:
the access destination information is a URL.

6. The label information providing method set forth in claim 5, wherein:
the access destination information is bar-coded information of the URL.

7. The label information providing method set forth in claim 1, wherein:
the label information is electronic data.

8. A label information providing method, comprising the steps of:
storing label information r elated to a label, which shows at least commodity information, in storage means by type of a commodity to which the label is affixed;
storing the commodity information included in the label information in the storage means by relating the commodity information to the label information; and
carrying out a search for label information which is stored in the storage means with reference to inputted commodity information and sending out label information corresponding to a search result to a user's terminal, when accessed by the user's terminal with reference to access destination information whereby a user requires downloading of the label information related to a label affixed to an arbitrary commodity, and the commodity information included in the label information which is required to be downloaded is inputted through the user's terminal.

9. The label information providing method set forth in claim 8, further comprising the step of:
including the access destination information in the commodity.

10. The label information providing method set forth in claim 9, wherein:
the access destination information is included in the same label that shows commodity information of the commodity.

11. The label information providing method set forth in claim 9, wherein:
the access destination information is included in a label which is different from a label showing commodity information of the commodity.

12. The label information providing method set forth in claim 8, wherein:
the access destination information is a URL.

13. The label information providing method set forth in claim 12, wherein:
the access destination information is bar-coded information of the URL.

14. The label information providing method set forth in claim 8, wherein:
the label information is electronic data.

15. A recording medium in which a label information providing program is recorded, the label information providing program for causing a computer to carry out the steps of:
storing label information r elated to a label, which shows at least commodity information, in storage means by type of a commodity to which the label is affixed; and
reading out the label information which is required to be downloaded from the storage means and sending out the label information to a user's terminal when accessed by the user's terminal with reference to access destination information whereby a user requires downloading of the label information related to a label affixed to an arbitrary commodity.

16. A recording medium in which a label information providing program is recorded, the label information providing program for causing a computer to carry out the steps of:
storing label information related to a label, which shows at least commodity information, in storage means by type of a commodity to which the label is affixed;
storing the commodity information included in the label information in the storage means by relating the commodity information to the label information; and
carrying out a search for label information which is stored in the storage means with reference to inputted commodity information and sending out label information corresponding to a search result to a user's terminal, when accessed by the user's terminal with reference to access destination information whereby a user requires downloading of the label information related to a label affixed to an arbitrary commodity, and the commodity information included in the label information which is required to be downloaded is inputted through the user's terminal.

17. A commodity which is used in a label information providing method and shows access destination information on a package, the label information providing method comprising the steps of:
storing label information related to a label, which shows at least commodity information, in storage means by type of a commodity to which the label is affixed; and
reading out the label information which is required to be downloaded from the storage means and sending out the label information to a user's terminal when accessed by the user's terminal with reference to access destination information whereby a user requires downloading of the label information related to a label affixed to an arbitrary commodity.

18. A commodity which is used in a label information providing method and shows access destination information on a package, the label information providing method comprising the steps of:
storing label information related to a label, which shows at least commodity information, in storage means by type of a commodity to which the label is affixed;
storing the commodity information included in the label information in the storage means by relating the commodity information to the label information; and
carrying out a search for label information which is stored in the storage means with reference to inputted commodity information and sending out label information corresponding to a search result to a user's terminal, when accessed by the user's terminal with reference to access destination information whereby a user requires downloading of the label information related to a label affixed to an arbitrary commodity, and the commodity information included in the label information which is required to be downloaded is inputted through the user's terminal.

19. A label information providing device, comprising:
storage means for storing label information related to a label, which shows at least commodity information, by type of a commodity to which the label is affixed; and
control means for reading out the label information which is required to be downloaded from the storage means and sending out the label information to a user's terminal when accessed by the user's terminal with reference to access destination information whereby a user requires downloading of the label information related to a label affixed to an arbitrary commodity.

20. The label information providing device set forth in claim 19, wherein:
the access destination information is included in the commodity.

21. The label information providing device set forth in claim 19, wherein:
the storage means further stores commodity provider information, the commodity provider who provides the commodity to a user; and
the control means judges whether or not commodity provider information inputted from the user's terminal exists in the information stored in the storage means, and only when judging that the commodity provider information exists in the storage means, sends out label information corresponding to a search result to the user's terminal.

22. The label information providing device set forth in claim 19, wherein:
the control means causes the storage means to store user information inputted from the user's terminal.

23. The label information providing device set forth in claim 19, wherein:
the control means causes the storage means to store user information and commodity provider information which are inputted from the user's terminal by relating the user information to the commodity provider information.

24. A label information providing device, comprising:
storage means for storing label information related to a label, which shows at least commodity information, by type of a commodity to which the label is affixed, while storing the commodity information included in the label information by relating the commodity information to the label information; and
control means for carrying out a search for label information which is stored in the storage means with reference to inputted commodity information and sending out label information corresponding to a search result to a user's terminal, when accessed by the user's terminal with reference to access destination information whereby a user requires downloading of the label information related to a label affixed to an arbitrary commodity, and the commodity information included in the label information which is required to be downloaded is inputted through the user's terminal.

25. The label information providing device set forth in claim 24, wherein:
the access destination information is included in the commodity.

26. The label information providing device set forth in claim 24, wherein:
the storage means further stores commodity provider information, the commodity provider who provides the commodity to a user; and
the control means judges whether or not commodity provider information inputted from the user's terminal exists in the information stored in the storage means, and only when judging that the commodity provider information exists in the storage means, sends out label information corresponding to a search result to the user's terminal.

27. The label information providing device set forth in claim 24, wherein:
the control means causes the storage means to store user information inputted from the user's terminal.

28. The label information providing device set forth in claim 24, wherein:
the control means causes the storage means to store user information and commodity provider information which are inputted from the user's terminal by relating the user information to the commodity provider information.
